(19) United States
(12) Patent Application Publication
(10) Pub. No.: US 2025/0007892 A1
(43) Pub. Date: Jan. 2, 2025

(54) Encrypted IoT Edge Communications

(71) Applicant: Texas Instruments Incorporated, Dallas, TX (US)

(72) Inventors: Veeramanikandan Raju, Bangalore (IN); Anand Kumar G, Bangalore (IN)

(21) Appl. No.: 18/345,108

(22) Filed: Jun. 30, 2023

(51) Int. Cl. H04L 9/40

(52) U.S. Cl. CPC H04L 63/0428; H04L 63/16; H04B 1/0007

(57) ABSTRACT

A network-communicating device with an analog-to-digital converter (ADC) having an output and encryption and selectivity circuitry for encrypting selected output values from the ADC.

### CROSS-REFERENCE TO RELATED APPLICATION

Not applicable.

### BACKGROUND

The described examples relate to internet of things (IoT) technology and more particularly to IoT encryption.

IoT devices are relatively less complex computing or computational devices that connect wirelessly to a network and communicate data between the device and the network. The IoT device may facilitate functionality in a product associated with the IoT device, for example, as is increasingly common with numerous consumer and household items. Often, an IoT device includes some type of sensor that measures or approximates a value of a parameter associated with the product. For example, a household thermostat may include an IoT sensor and a transceiver that captures temperature data, an IoT camera may include a photographic sensor that captures image data, an IoT smart plug may include a sensor that captures on/off and related data, and so forth. The IoT device then communicates such data to a wireless network. The sensed data, or its corresponding measure, may then pass from the network to a remote processor or processing facility which may evaluate or otherwise act upon the data, and may or may not respond to the IoT device in response to the received data period.

In sensing applications, such as in the devices described above, an analog-to-digital converter (ADC) may be used to convert an analog signal, received from a sensor, into a digital value for application processing. Accordingly, an IoT device may include such an ADC and the digital data from the ADC may be communicated wirelessly to a nearby network, which then communicates that data to a remote processor. Sometimes the data is real-time data, and the IoT device may be referred to as an edge device, for example when the IoT device has sufficient storage and/or computational ability to process the data at acceptable application-specific computational speed. Most of the digital data processed at the processing end (be it cloud or at a host processor) may be susceptible to attacks if the raw data is not protected. An attacker may utilize this digital data for any possible attack, for example, controlling the IoT device or exploiting the data (and/or the user/owner of the IoT device). To protect against such exploits, conventionally digital data at a processing receiver may execute runtime security methods, for example by processing the data in an isolated context so that attackers have lesser possibility of accessing, and attacking, the digital data. However, the ADC digital data may be accessible to an attacker even before the processing element can start processing the data, thereby making the data vulnerable.

Examples are provided in this document that may improve on various of the above considerations as well as other concepts, as further detailed below.

### SUMMARY

In one example, there is a network-communicating device, comprising a signal input adapted to receive a sensor-derived signal; an analog-to-digital converter (ADC) having an input coupled to the signal input and an output; an encryption circuit having an input coupled to the output of the ADC and further having an enable input; a selective encryption enable circuit having an output coupled to the enable input; and a signal output coupled to an output of the ADC and an output of the encryption circuit.

Other aspects are also disclosed and claimed.

### BRIEF DESCRIPTION OF THE DRAWINGS

FIG. 1 is an electrical block diagram of an IoT device 100.

FIG. 2A is an electrical diagram of an IoT device 200, as an example implementation for the FIG. 1 IoT device 100 and using a count for selectively encrypting data blocks.

FIG. 2B illustrates a sequence of N data blocks, DB1 through DBN as an example for FIG. 2A.

FIG. 3A is an electrical diagram of an IoT device 300, as another example implementation for the FIG. 1 IoT device 100 and using a data threshold for selectively encrypting data blocks.

FIG. 3B illustrates a sequence of N data blocks, DB1 through DBN as an example for FIG. 3A.

FIG. 4A is an electrical diagram of an IoT device 400, as another example implementation for the FIG. 1 IoT device 100 and using randomness for selectively encrypting data blocks.

FIG. 4B illustrates a sequence of N data blocks, DB1 through DBN as an example for FIG. 4A.

### DETAILED DESCRIPTION

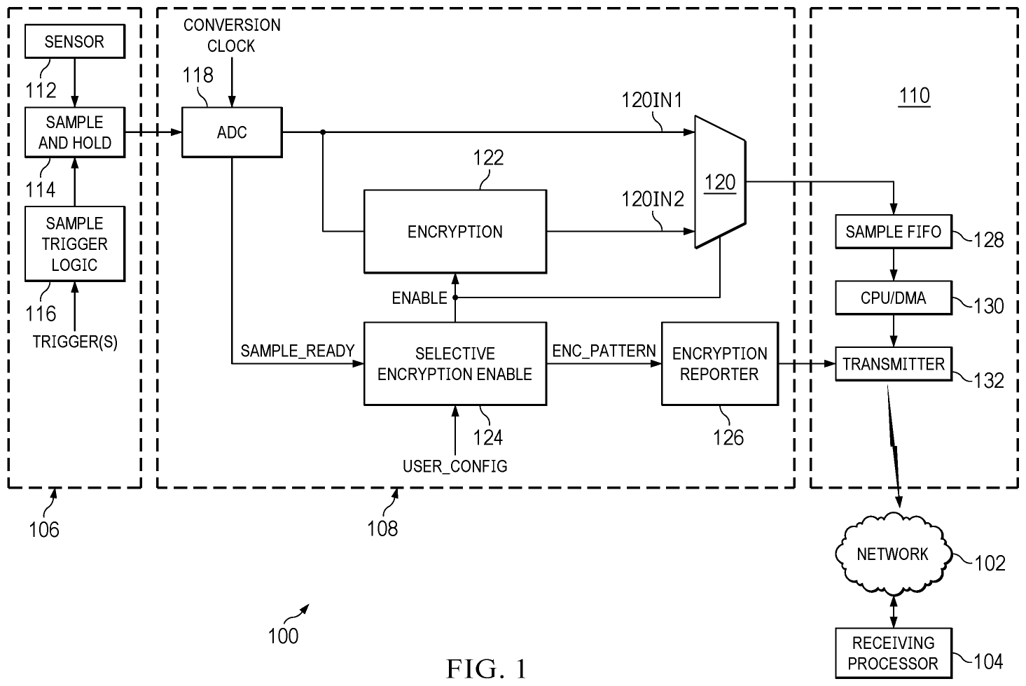

FIG. 1 is an electrical block diagram of an IoT device 100. The IoT device 100 may be implemented as part of various consumer or commercial device applications, and may be powered by a battery or a commercial or residential, and/or continuous or switched (e.g., line), power source. The IoT device 100 is a network-communicating device and, as such, communicates with a network 102. A receiving processor 104 is also coupled to the network 102, so that it may receive and process information from the IoT device 100, via the network 102. Bidirectionally, the receiving processor 104 also may communicate back to the IoT device 100, via the network 102.

The IoT device 100 includes one or more circuits, which may be separable or provided as one more integrated circuits (ICs). The IC(s) will be described as, and for purposes of introduction are divided into, three circuit domains: (i) a data sensing domain 106; (ii) a digital data production domain 108; and (iii) a data transmission domain 110. The various blocks in the three circuit domains can be implemented with circuitry having separable or overlapping boundaries, and may be implemented in part by sequential/processing/executing circuitry, such as logic circuitry, a controller, a processor, and the like. Such circuitry also may include, or have access to, programming code accessible from a readable memory store, where access and execution of such programming code can implement some of the functionality described in this document. The data sensing domain 106 has an output connected to an input of the digital data production domain 108. The digital data production domain 108 has an output connected to an input of the data transmission domain 110. Generally, the data sensing domain 106 senses data applicable to functionality of the IoT device 100. The data sensing domain 106 outputs the sensed data to the digital data production domain 108. The digital data production domain 108 converts the sensed data to digital values, and it also selectively encrypts, and optionally reports the encryption, to the data transmission domain 110. The data transmission domain 110 wirelessly transmits the selectively encrypted data, and optionally the reported encryption, to the network 102, so long as the network is within range of the IoT device 100. Thereafter, the selectively encrypted data may be processed by the receiving processor 104, by accessing it from the network 102.

The data sensing domain 106 includes a sensor 112, a sample and hold circuit 114, and a sample trigger logic circuit 116. An output of the sensor 112 is connected to a data input of the sample and hold circuit 114. An output of the sample trigger logic circuit 116 is connected to an enable input of the sample and hold circuit 114. A trigger signal, or signals, is connected to an input of the sample trigger logic circuit 116. The sensor 112 includes circuitry for sensing one or more attributes, for example with the attribute being present and proximate or within the configuration that includes the IoT device 100. The sensor 112 also produces an analog signal, corresponding to or representing the sensed attribute. The analog signal is coupled to the sample and hold circuit 114 input, which once enabled by the sample trigger logic 116, samples the analog signal from the sensor 112 and holds it at a near constant voltage (and/or current) during an analog-to-digital conversion. Specifically, one or more trigger signals may be provided by either software, or hardware, or both. In response to assertion of one or more of these trigger signals, the sample trigger logic 116 outputs an enabling signal to the sample and hold circuit 114 enable input, and the sample and hold circuit 114 responds by sampling the analog signal from the sensor 112 and holding that value (e.g., voltage) for a predetermined duration. Accordingly, if the analog output from the sensor 112 changes during the predetermined period, the output of the sample and hold circuit 114 remains unchanged.

The digital data production domain 108 includes an ADC 118, a multiplexer 120, an encryption circuit 122, a selective encryption enable circuit 124, and an encryption reporter circuit 126. An input of the ADC 118 is connected to receive a sensor-derived (e.g., sampled) signal, here from an output of the data sensing domain 106. The ADC 118 is operated (cycled) by a conversion clock signal. A data output of the ADC 118 is connected to a first input 120IN1 of the multiplexer 120. The data output of the ADC 118 is also connected as an input to the encryption circuit 122. The output of the encryption circuit 122 is connected to a second input 120IN2 of the multiplexer 120. An ENABLE output of the selective encryption enable circuit 124 is connected to both an input of the encryption circuit 122 and a control input of the multiplexer 120. A SAMPLE_READY output is connected from the ADC 118 to an enable input of the selective encryption enable circuit 124. The selective encryption enable circuit 124 also may include a configurable input, which if included may receive a signal, shown as USER_CONFIG, by which a user can control one or the other of the type of encryption implemented, or a variable of a selected encryption technique, as further detailed later. Also in this regard, the selective encryption enable circuit 124 may include sufficient circuitry to implement the user selection, for example as a programmable control register, selection table, or the like. An ENC_PATTERN signal is connected from the selective encryption enabled circuit 124 to the encryption reporter circuit 126. An output of the encryption reporter circuit 126 is connected to the data transmission domain 110.

The general operation of the digital data production domain 108 is now described, with additional details provided later in connection with various alternative implementation examples. The ADC 118 samples analog signals from the data sensing domain 106, as synchronized and at a frequency set by the conversion clock, and in response outputs a corresponding digital data of N bits (e.g., N=16) that is proportional to the voltage at the input of the ADC 118. Each time a digital sample value is ready from the ADC 118, it asserts SAMPLE_READY to the selective encryption enable circuit 124. The selective encryption enable circuit 124 then determines whether or which data sample is to be encrypted, and it controls the encryption circuit 122 to apply an encryption technique when desired. As further detailed below, the encryption circuit 122 is operable to apply, and potentially to select from multiple different types of, an encryption technique(s), to data sampled by the ADC 118. Accordingly, when encryption is desired, the selective encryption enable circuit 124 asserts the ENABLE signal to enable the encryption circuit 122, which executes a type of encryption to encrypt a data block received from the ADC 118. Conversely, when the ENABLE signal is not asserted, the encryption circuit 122 may be inhibited from encrypting data samples to save power. The combination of circuits 122 and 124 thereby permits selective encryption, that is, the encryption circuit 122 applies a designated encryption technique to some, but not all (i.e., selectively), of the digital data output by the ADC 118. As a result, the first input 120IN1 of the multiplexer 120 receives all digital samples output by the ADC 118, while the second input 120IN2 of the multiplexer 120 receives only selectively encrypted ones of those digital samples. Further, the control and data inputs of the multiplexer 120 are connected to permit selection of either non-encrypted digital data from the output of the ADC 118 or, alternatively selectively encrypted data from the output of the encryption circuit 122. Particularly, when an output digital data sample from the ADC 118 is not to be encrypted, the multiplexer 120 selects that data and outputs it. Conversely, when a digital data output from the ADC 118 is selectively encrypted, the encrypted digital data from the encryption circuit 122 is selected by the multiplexer 120 for output. The alternative selection as between data from the ADC 118 and data from the encryption circuit 122 may be implemented by the multiplexer 120 control signal, as provided or derived from the selective encryption enable circuit 124. Additionally, in some examples, when data is selectively encrypted, the selective encryption enable circuit 124 provides information representative of the selectivity, that is, some form of mapping, table, flag(s), or other indication of which data units from the ADC 118 are selectively encrypted, with that information represented in FIG. 1 as the ENC_PATTERN signal. The ENC_PATTERN signal is provided to an encryption reporter 126, which is coupled to provide this information, at an appropriate time and in an appropriate form, to the transmit domain 110, so the ENC_PATTERN also may be communicated to the network 102 and the receiving processor 104. When the receiving processor 104 receives the ENC_PATTERN, it is thereby notified of which data it receives from the IoT device 100 is selectively encrypted, and in response the receiving processor 104 may then decrypt only those encrypted data blocks, while processing the remaining blocks received from the IoT device 100 as unencrypted data.

The data transmission domain 110 includes a sample first in first out (FIFO) circuit 128, a central processing unit (CPU)/direct memory access (DMA) circuit 130, and a transmitter 132. An input of the sample FIFO circuit 128 is connected to an output of the multiplexer 120. An output of the sample FIFO 128 is connected to an input of the CPU/DMA circuit 130. An output of the CPU/DMA circuit 130 is connected to an input of the transmitter 132. The output of the transmitter 132 is intended to indicate wireless transmission of data, for example to an appropriate radio frequency/antenna or other applicable interface for wireless communications.

The operation of the data transmission domain 110 is now described. As digital samples (either encrypted or unencrypted) are output by the multiplexer 120, those samples are stored into the sample FIFO 128. The CPU/DMA circuit 130 represents one or more alternatives for retrieving data from a memory store, which in this case is the sample FIFO 128, and forwarding the retrieved data for transmission. In the illustrated example, the retrieved and forwarded data is provided to the transmitter 132, which transmits such data wirelessly to the network 102. Accordingly, the transmitter 132 provides a data gateway to the network 102, within range of the transmitter, for example using a WiFi-implemented protocol. Once the data reaches the network 102, it may be processed by an appropriate device(s) having access, either directly or through other intermediate paths or nodes, to that network 102, so as to include the receiving processor 104.

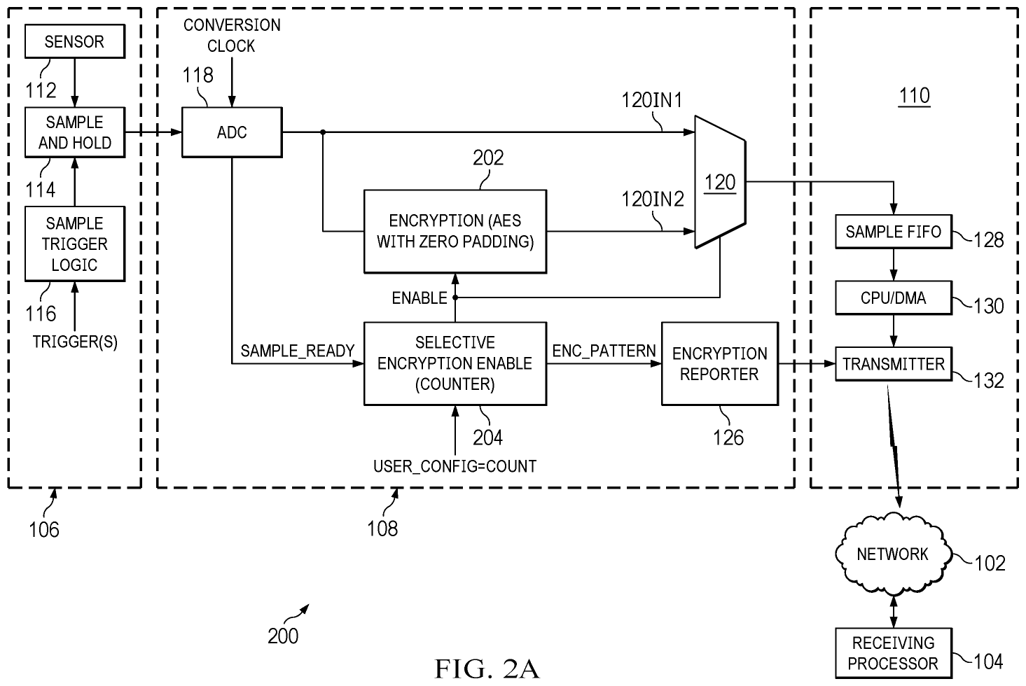

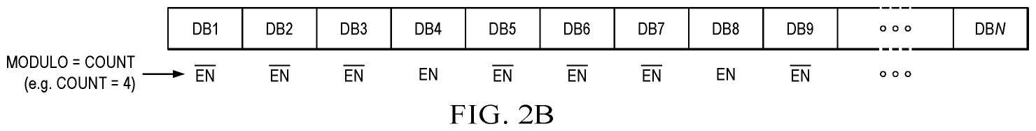

FIG. 2A is an electrical diagram of an IoT device 200, as an example implementation for the FIG. 1 IoT device 100. In FIG. 2A and later drawings, common reference numbers are used with FIG. 1 to illustrate the same, or comparable, circuit blocks. Accordingly, the following discussion focuses primarily where certain blocks are modified or explained with respect to particular implementation details.

In FIG. 2A, in the digital data production domain 108, an encryption circuit 202 is shown in place of the FIG. 1 encryption circuit 122. The encryption circuit 202 implements, by way of example, a particular type of encryption, namely, encryption according to the advanced encryption standard (AES). The implemented AES encryption technique may use one of different key lengths, such as AES-128, AES-192, or AES-256. Further, as data blocks to be encrypted are received by the encryption circuit 202 from the ADC 118, those data blocks may be a bit-size other than that anticipated by the type of implemented encryption. For example, where the encryption circuit 202 implements AES, then a 128-bit sample is anticipated for encryption. However, in the example described above, the ADC 118 outputs a digital value with N=16 bits. Accordingly, additional adaptation is included for the digital data value, for example by zero padding any lower significant bit positions beyond those provided from the ADC output—in the example provided, zero padding the 128−16=112 least significant bits-so as to facilitate the applied encryption. Also in the digital data production domain 108, a selective encryption enable circuit 204 is included in place of the FIG. 1 selective encryption enable circuit 124. The selective encryption enable circuit 204 includes a counter and circuitry for asserting the ENABLE signal each time a predetermined count threshold of data blocks is reached (counting 1, 2, . . . to the predetermined count threshold), after which the current count value is cleared and starts anew with a next data block. The predetermined count threshold may be provided to (e.g., programmed) the selective encryption enable circuit 204 by user configuration, and is correspondingly shown in FIG. 2A by the reference of USER_CONFIG=COUNT. In an example shown below in FIG. 2B, COUNT=four.

FIG. 2B illustrates a sequence of N data blocks, DB1 through DBN. Each data block, DBx (x=1, 2, . . . , N), may represent a same number of bits, bytes, or other data quantities forming a unit of digital data output from the ADC 118. FIG. 2B also shows, in a horizontal row below the data blocks, an ENABLE sequence depicting the logical value of the FIG. 2A ENABLE signal as intended to correspond, or direct, whether encryption is applied to each respective data block DBx. For simplification, an asserted value of ENABLE is shown as EN, and a de-asserted value of ENABLE is shown as E̅N̅. For example, the first data block in the sequence is DB1, and the corresponding value of ENABLE is de-asserted, as shown as E̅N̅, thereby intending to direct that DB1 is not to be encrypted. The remainder of the sequence either asserts or de-asserts the ENABLE signal according to a modulo count value set by the above-referenced USER_CONFIG=COUNT. Accordingly, where COUNT=four, then FIG. 2B shows the ENABLE values in sets of four, where each set starts with three, de-asserted ENABLE signals, followed by a fourth, and asserted, ENABLE signal. Returning to FIG. 2A, and in combination with the FIG. 2B ENABLE sequence, note the selective encryption enable circuit 204 will de-assert ENABLE for the first three data block values output by the ADC 118. Accordingly, the de-asserted ENABLE causes the multiplexer 120 to select data at its first input 120IN1, namely, from the output of the ADC 118, and output that data to the sample FIFO 128. However, for the fourth data block value output by the ADC 118, the selective encryption enable circuit 204 asserts the ENABLE signal. In response to the asserted ENABLE signal, the encryption circuit 202 zero pads the least significant bits (e.g., 112 of those bits) of the fourth data block value output from the ADC 118 and applies the available encryption technique (e.g., AES). Also in response to the asserted ENABLE signal, the multiplexer 120 selects data at its second input 120IN2, namely, the output of the encrypted data provided by the encryption circuit 202, and it outputs that data to the sample FIFO 128.

Given the example of FIGS. 2A and 2B, the IoT device 100 data sensing domain 106 may sense (e.g., using the sensor 112) an attribute and provide a corresponding analog signal, for each of a series of sampled signals. The digital data production domain 108 may convert each analog signal sample value to a corresponding digital value (e.g., using the ADC 118), while selectively encrypting only some of those samples (e.g., every fourth sample), while leaving other samples unencrypted. Lastly, the data transmission domain 110 transmits a stream of data values, some encrypted, others unencrypted, to the network 102 and thereby making them available for processing (e.g., by the receiving processor 104). The preceding aspects can have any one or more benefits. For example, selective encryption provides some protection against nefarious data attacks or access, but avoids the need for additional resources that would be required for full data stream encryption. For instance, selective encryption can reduce storage (e.g., memory), power consumption (e.g., battery), device size, complexity, and processing capability, any one or more of which may be particularly desirable and/or advantageous in an IoT device. As another example, different user configurable settings for the COUNT allows the user to set what percent, from fifty percent (e.g., COUNT=2) or less (e.g., COUNT>2) of the data samples, are selectively encrypted. For example, in the approach of a COUNT for establishing an amount of total data that is encrypted, or in other approaches described below, encryption may be in a range from 10 percent to 25 percent of all ADC samples, although other values may be preferred based on various application-specific criteria. In any event, the user may implement or select different selective encryption policies depending on various criteria, including the nature of analog input being sensed and application needs, in order to set the user configurable parameter for controlling the amount of selective encryption. For example, a desired or preferable range of what amount of ADC values as selectively encrypted can be user configurable based on the following factors: (i) the sampling rate of the ADC, for instance, the higher the sampling rate, a higher percentage of samples can be encrypted to minimize the probability of re-use of data by the attacker; or (ii) the precision of the ADC, for instance, a relatively higher ADC precision can have a higher percentages of samples encrypted, for example, selectively encrypting at a higher percentage for a 14-bit ADC than a 12-bit ADC. In any event, generally the user-configurability allows the user to reduce the probability of usage of data by the attacker by means of increasing or decreasing the percentage of encrypted samples.

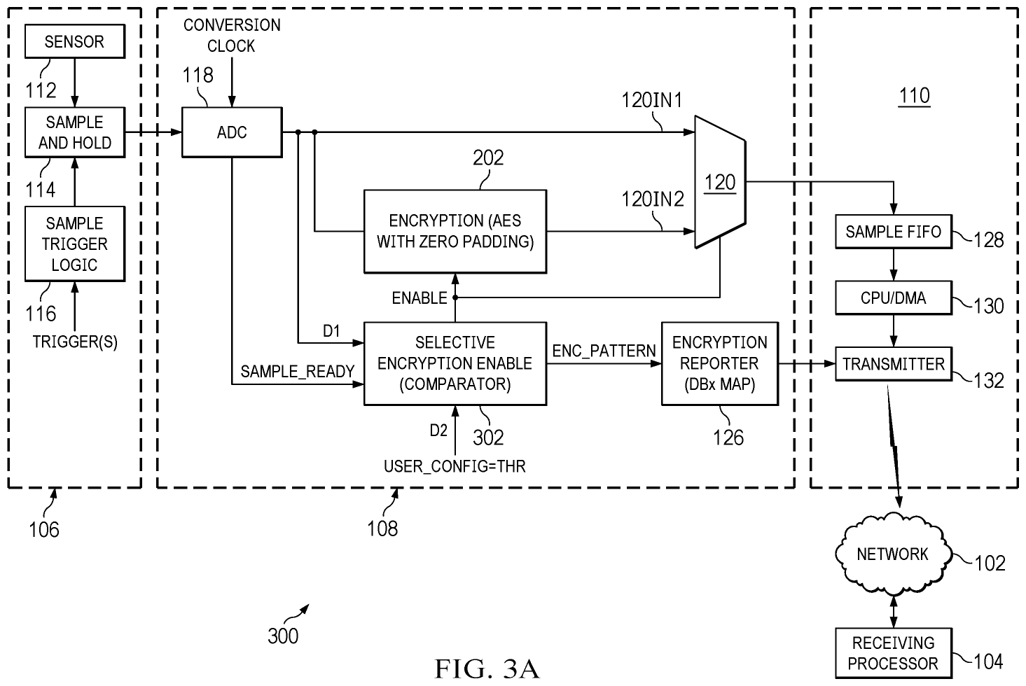

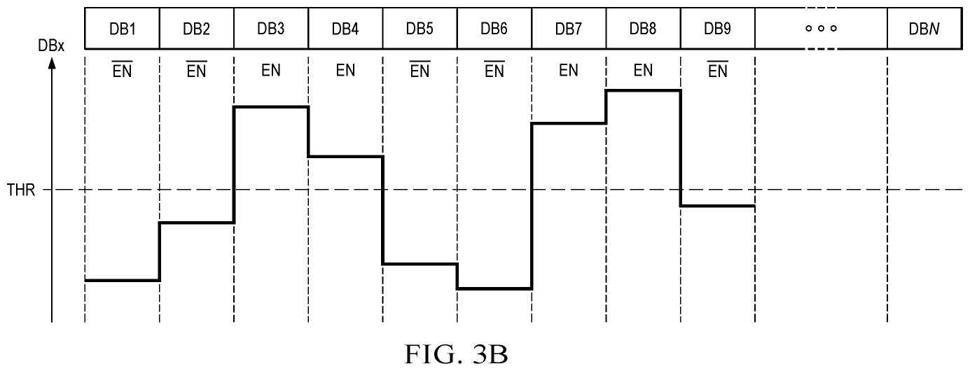

FIG. 3A is an electrical diagram of an IoT device 300, as another example implementation for the FIG. 1 IoT device 100. In FIG. 3A, the encryption circuit 202 again implements AES, but note that for this example, and others, alternative encryption may be used. Further, in some examples, alternative types of encryption may be selectable, with the selectivity either within the device or available by external signal or control to a user. A selective encryption enable circuit 302 includes circuitry for asserting the ENABLE signal, but in FIG. 3A the selectivity is based on a comparison of the digital sample value output from the ADC 118, indicated in FIG. 3A as a data value D1, to a threshold value. In an example, the threshold value can be indicated as a value, THR, provided by the user through the USER_CONFIG interface, as a second data value D2. Accordingly, the selective encryption enable circuit 302 compares D1 and D2, and asserts or de-asserts the ENABLE signal, to the encryption circuit 202, based on the comparison result. In some such examples, the digital sample values with the least magnitude, which may be indicative of a period of time during which the sensor values are dominated by noise, may be compressed or may be compressed more often, while digital samples values with the greatest magnitude, which may be indicative of a period of time during which the sensor values are particularly relevant, may not be compressed or may be compressed less often. Additionally or in the alternative, the digital sample values with the greatest magnitude, which may produce the greatest savings when compressed, may be compressed or may be compressed more often, while digital samples values with the least magnitude, which may benefit less from compression, may not be compressed or may be compressed less often. An example of the user providing USER_CONFIG=THR, and the responsive operation, is shown below.

FIG. 3B illustrates a sequence of N data blocks, DB1 through DBN, in a same manner introduced above in FIG. 2B. FIG. 3B also illustrates an example, in a horizontal row below the data blocks, of an ENABLE sequence depicting the logical values of the FIG. 3A ENABLE signal as intended to correspond, or direct, whether encryption is applied to each respective data block DBx. Beneath the row of ENABLE signals, FIG. 3B illustrates the magnitude of each digital output value DBx from the ADC 118. Lastly, FIG. 3B illustrates an example value for USER_CONFIG=THR. In the illustrated example, some values of DBx are below THR (i.e., values, DB1, DB2, DB5, DB6, and DB9), and some values of DBx are above the THR (i.e., values DB3, DB4, DB7, and DB8). Further, the ENABLE signal is asserted (EN) when the DBx values is above THR, and the ENABLE signal is de-asserted (EN) when the DBx value is below THR. Returning to FIG. 3A, and in combination with the ENABLE sequence of FIG. 3B, note the selective encryption enable circuit 302 will de-assert ENABLE for the first two data block values output by the ADC 118. Accordingly, the de-asserted ENABLE causes the multiplexer 120 to select data at its first input 120IN1, namely, from the output of the ADC 118, and output that data to the sample FIFO 128. However, for the third and fourth data block value output by the ADC 118, the selective encryption enable circuit 202 asserts the ENABLE signal. In response to the asserted ENABLE signal, the encryption circuit 202 applies the available encryption method (e.g., AES) to the third and fourth data block value output from the ADC 118, and the multiplexer 120 selects the encrypted data output by the selective encryption circuit 202, from its second input 120IN2, and outputs that encrypted data to the digital data production domain 108. The same operation continues for the remaining data values, with DB5, DB6, and DB9 remaining unencrypted by the digital data production domain 108 and passing to the data transmission domain 110, and with values DB7 and DB8 being encrypted by the digital data production domain 108 and passing to the data transmission domain 110.

Also in connection with the IoT device 300, the ENC_PATTERN provides an indication to the encryption reporter circuit 126 of each data value that is encrypted. In the example of FIG. 3B, therefore, the ENC_PATTERN identifies values DB3, DB4, DB7, and DB8. This information may be encoded and then reported by the encryption reporter circuit 126 to the data transmission domain 110 in various manners. In one example, the ENC_PATTERN can be a bitmap, e.g., a fixed number of bits that map correspondingly to a like number of data values, and with complementary values either set (e.g., logical one) or cleared (e.g., logical zero) to indicate whether a corresponding data value is encrypted. For example in FIG. 3B, the ENC_PATTERN could be an 8-bit value, for example encoded in a circular buffer, corresponding to data values DB1 through DB8, and for the example shown, then ENC_PATTERN=00110011. The reporter circuit 126 provides this information to the data transmission domain 110, so that it may be communicated to the receiving processor 104. Note that additional security may be imposed on this information, for example communicating it along a secure channel, or with its own encryption (e.g., asymmetric key). As an alternative, note that the ENC_PATTERN may be included as part of the data values, for instance by including an additional bit stamp for each data value, and with the additional bit serving as a flag for the corresponding data value, again in one state indicating the data value is encrypted, or in an another (e.g., complementary) state indicating the data value is unencrypted. Different tradeoffs may exist in the above approaches, with the secure channel increasing communication complexity, and the bit stamping including storage requirements in the data transmission domain 110.

Given the preceding, the selective encrypting can be achieved by the IoT device 300 based on the value of each digital sample as compared to a threshold. Further, the threshold can remain the same, or can be altered, for example by user input. As one example, the threshold might be set based on anticipated patterns in the data. For example, the IoT device 300, or its sensor 112, may be for sensing data that, during some low-interest periods, are expected to be low and of little consequence to the environment being sensed. In such an instance, THR may be set above the anticipated value(s) during the low-interest periods, so that all data during that period is unencrypted, and while therefore more susceptible to access, also of lesser concern due to being from a low-interest time frame. Conversely, during periods of interest where data is expected to exceed THR, that data will be encrypted and therefore less vulnerable to attack. As another example, the threshold can vary, based on changes in data, for instance adjusting the threshold based on a moving average of data over a period.

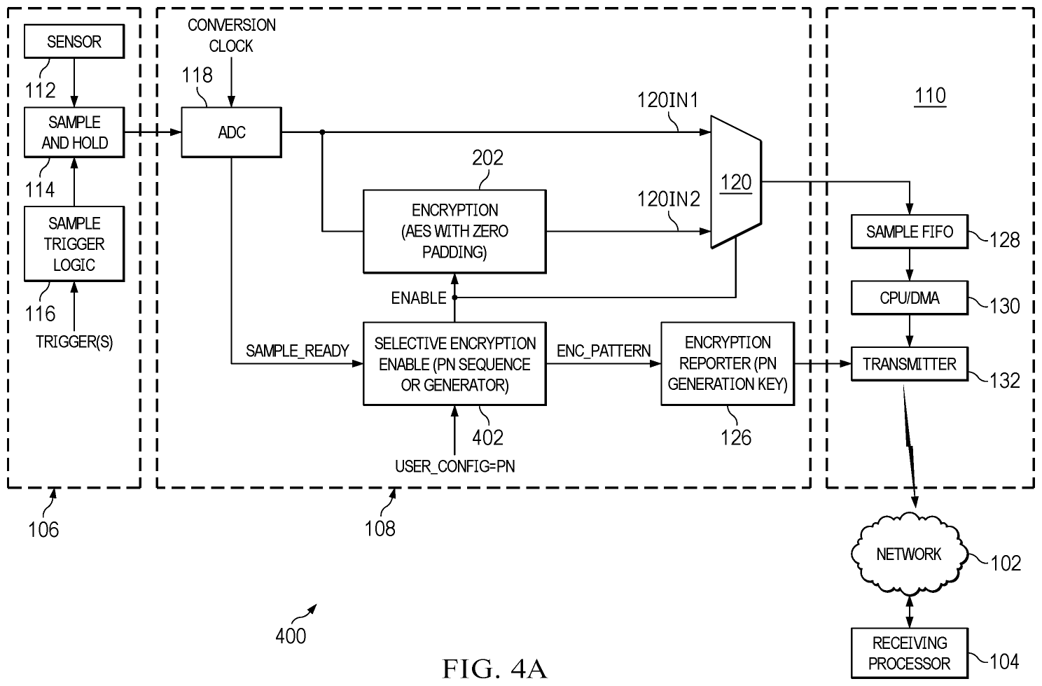

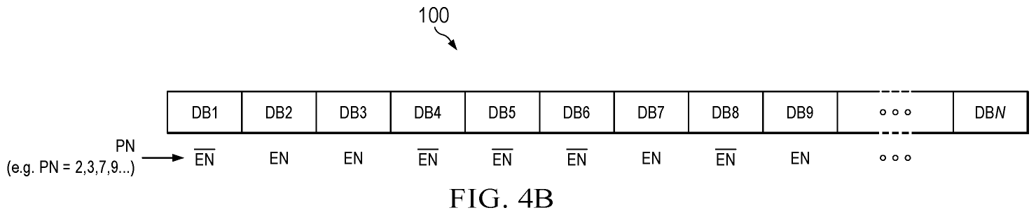

FIG. 4A is an electrical diagram of an IoT device 400, as another example implementation for the FIG. 1 IoT device 100. In FIG. 4A, the selective encryption circuit 202 again implements AES (or an alternative). A selective encryption enable circuit 402 includes circuitry for asserting the ENABLE signal, but in FIG. 4A the selectivity is based on randomness. Accordingly, in one example the USER_CONFIG signal can provide a random (including pseudorandom) sequence, or in an alternative example the USER_CONFIG signal can enable (or disable) a pseudorandom number (PN) generator included in the encryption enable circuit 402. The cost of the PN generator at the source and destination ends depends on the degree and quality of the encryption that needs to be achieved in the given application. For example, the USER_CONFIG signal can enable a PN generator within the encryption enable circuit 402, and which generates the PN number sequence. The sequence can be seeded using different methods, for example by selecting from among a set of orthogonal codes, stored in the encryption enable circuit 402, for example in a look up table (LUT). For example, one method may address the LUT in a predictable and static manner to choose the seed from among the different values stored in the LUT. As another example, a pseudorandom number may be used to choose an address in the LUT, thereby randomly accessing the seed from the LUT. In either event, the seed is then used to generate the remaining PN sequence. The PN sequence will necessarily increase or otherwise provide a correspondence with selected ones of the increasing index of each successive data value output by the ADC 118. For example, the PNs can be provided, or adapted, so as to be increasing (but not immediately incremental) order, so as to relate to different ones of the digital values output by the ADC 118. An example is shown in FIG. 4B.

FIG. 4B illustrates a sequence of N data blocks, DB1 through DBN, and a corresponding set of enable signals, in a same manner introduced above in FIGS. 2B and 3B. Beneath the row of ENABLE signals, FIG. 4B also illustrates a series of increasing PN integer values. Each PN value is intended to identify a corresponding one of the data values to be encrypted. Accordingly, for the illustrated PN sequence of 2, 3, 7, 9, . . . , the intent is that the corresponding data values DB2, DB3, DB7, and DB9 are to be encrypted, as also shown by the respective FIG. 4B indications of asserted ENABLE (EN) de-asserted ENABLE (EN). Once more, the ENABLE signal both enables selective encryption and also switches the data path (via the multiplexer 120) in the digital data production domain 108 to select and output unencrypted data when ENABLE is de-asserted and encrypted data when ENABLE is asserted.

Also in connection with the IoT device 400, the ENC_PATTERN provides an indication to the encryption reporter circuit 126 of either each data value that is encrypted or some mechanism from which the PN can be reported to, or recreated by, the receiving processor 104, so that the receiving processor 104 can identify which of the data is encrypted and correspondingly decrypt such data. For example, the generation key used to create the PN at the IoT device 400 can be provided as the ENC_PATTERN and securely reported to the receiving processor 104 (by and through the encryption reporter circuit 126 and the data transmission domain 110). Different reporting examples may include at least one of two examples to securely provide this generation key. First, the key may be statically embedded for query in a given register, where the register is protected for authorized access only based on a software authentication mechanism. For example to protect the register, an application program interface (API) can be developed to provide the register value with key information, where the API also can be further protected by requiring authenticated by external means. Second, the generation key can be dynamically exchanged through a Public/Private Key challenge.

From the above, described examples provide a network-communicating device (e.g., IoT device) that can sample signals, selectively encrypt certain of those signals, and transmit the sampled signals, some encrypted, some unencrypted, to a network and/or processing device. Selectivity of authentication can be user controlled, whereby a user can select among types of encryption, different types of selectivity, and/or different variables within a same type of selectivity. These alternatives may provide any one or more of various advantages. For example, the device may reduce or avoid attacks on ADC data sensing and thereby permit securing sensing capabilities, for example to IoT devices. As compared to fully encrypted data, selective encryption reduces the sensing overhead and processing overhead during sensing and post-processing. More particularly, where encryption is implemented for each data sample, processing resources are commensurately expended, which can further reduce resources (and time) during which analog signal sampling may be implemented. Power and complexity may be reduced both on the transmitting and receiving sides of the sample process, in that not all samples require encryption/decryption. Original equipment manufacturers or other implementers of this technology can monetize data while experiencing protection from cloud-based and/or third party data attacks or usage, as may be particularly advantageous in industrial IoT and critical where such data facilitates additional (e.g., and industrial) control. Other benefits include variations and modifications to the structure, where certain examples have been provided. Accordingly, additional modifications are possible in the described embodiments, and other examples are possible, within the scope of the following claims.

What is claimed is:

1. A network-communicating device, comprising:
a signal input adapted to receive a sensor-derived signal;
an analog-to-digital converter (ADC) having an input coupled to the signal input and an output;
an encryption circuit having an input coupled to the output of the ADC and further having an enable input;
a selective encryption enable circuit having an output coupled to the enable input; and
a signal output coupled to an output of the ADC and an output of the encryption circuit.

2. The network-communicating device of claim 1 and further including a user-configurable circuit having an input adapted to receive a user-configurable parameter and an output coupled to the selective encryption enable circuit.

3. The network-communicating device of claim 2 wherein the user-configurable circuit includes circuitry adapted to enable the encryption circuit for a type of encryption in response to the user-configurable parameter.

4. The network-communicating device of claim 2:
wherein the ADC is adapted to provide a sequence of data values; and
wherein the user-configurable circuit includes circuitry adapted to enable the encryption circuit to encrypt selected ones of the data values in response to the user-configurable parameter.

5. The network-communicating device of claim 1 wherein the selective encryption enable circuit includes circuitry adapted to assert an enable signal to the output of the selective encryption enable circuit.

6. The network-communicating device of claim 1 wherein the selective encryption enable circuit includes circuitry adapted to assert an enable signal to the output of the selective encryption enable circuit based on a count of signal samples processed by the ADC.

7. The network-communicating device of claim 1 wherein the selective encryption enable circuit includes circuitry adapted to assert an enable signal to the output of the selective encryption enable circuit based on a value output by the ADC.

8. The network-communicating device of claim 1 wherein the selective encryption enable circuit includes circuitry adapted to assert an enable signal to the output of the selective encryption enable circuit based on a comparison of a value output by the ADC to a threshold value.

9. The network-communicating device of claim 1 wherein the selective encryption enable circuit includes circuitry adapted to assert an enable signal to the output of the selective encryption enable circuit based on a pseudorandom number sequence.

10. The network-communicating device of claim 9 wherein the selective encryption enable circuit includes circuitry adapted to assert an enable signal to the output of the selective encryption enable circuit based on a pseudorandom number selected from a lookup table.

11. The network-communicating device of claim 9 wherein the selective encryption enable circuit includes circuitry adapted to assert an enable signal to the output of the selective encryption enable circuit based on a pseudorandom number selected, in response to a pseudorandom access from a lookup table.

12. The network-communicating device of claim 1 and further including a sensor having an output coupled to the signal input.

13. The network-communicating device of claim 1 and further including a transmitter circuit coupled to the signal output.

14. The network-communicating device of claim 13 and further including a switching circuit, the switching circuit coupled between the output of the ADC and the signal output and also coupled between the output of the encryption circuit and the signal input.

15. The network-communicating device of claim 13 and further including an encryption reporter circuit coupled between the selective encryption enable circuit and the transmitter circuit, wherein the ADC is adapted to provide a sequence of data values and the encryption reporter circuit is adapted to provide an indication of which data values, in the sequence of data values, are selectively encrypted.

16. The network-communicating device of claim 1 wherein the signal input, ADC, encryption circuit, selective encryption enable circuit, and signal output comprise an IoT device.

17. A network system, comprising:
a first network-communicating device, adapted to be coupled to a network and comprising:
a signal input adapted to receive a sensor-derived signal;
an analog-to-digital converter (ADC) having an input coupled to the signal input and an output;
an encryption circuit having an input coupled to the output of the ADC and further having an enable input;
a selective encryption enable circuit having an output coupled to the enable input; and
a signal output coupled to an output of the ADC and an output of the encryption circuit; and
a second network-communicating device, adapted to be coupled to the network and comprising processing circuitry adapted to process encrypted and unencrypted data coupled to the network by the first network-communicating device.

18. The network system of claim 17 wherein the processing circuitry is further adapted to decrypt data selectively encrypted, and coupled to the network, by the first network-communicating device.

19. The network system of claim 17 wherein the first network-communicating device further includes a transmitter and an encryption reporter circuit coupled between the selective encryption enable circuit and the transmitter, wherein the ADC is adapted to provide a sequence of data values and the encryption reporter circuit is adapted to provide an indication of which data values, in the sequence of data values, are selectively encrypted, and wherein the second network-communicating device is further adapted to decrypt data selectively encrypted, and coupled to the network, by the first network-communicating device and in response to the indication.

20. A method of operating a network-communicating device, comprising:
receiving, from a sensor, a plurality of sensor-derived analog signals at a signal input;
converting each of the plurality of sensor-derived analog signals into a corresponding digital value, thereby providing a plurality of digital values;
encrypting selected ones of the plurality of digital values into encrypted values and coupling the encrypted selected ones to an output;
coupling unselected ones of the plurality of digital values as unencrypted values to the output.
